(19) United States
(12) Patent Application Publication
(10) Pub. No.: US 2024/0422279 A1
(43) Pub. Date: Dec. 19, 2024

(54) IMAGE PROCESSING APPARATUS, IMAGE PROCESSING METHOD, AND COMPUTER-READABLE RECORDING MEDIUM STORING IMAGE PROCESSING PROGRAM

(71) Applicant: Sharp Kabushiki Kaisha, Osaka (JP)

(72) Inventor: TAKASHI YAMAMOTO, Osaka (JP)

(21) Appl. No.: 18/741,814

(22) Filed: Jun. 13, 2024

(30) Foreign Application Priority Data
Jun. 14, 2023 (JP) 2023-097586

(51) Int. Cl. H04N 1/393; G06V 30/12

(52) U.S. Cl. CPC H04N 1/393; G06V 30/12

(57) ABSTRACT

An image processing apparatus includes: a second image generator that generates, based on a first image, at least one second image obtained by reducing the first image at a predetermined resizing ratio; a character-recognition success count determiner that performs character recognition on the first image and the second image and determines a character-recognition success count for the first image that is the number of characters for which the character recognition on the first image is successful and a character-recognition success count for the second image that is the number of characters for which the character recognition on the second image is successful; a condition determiner that determines, for the second image, whether a ratio of the character-recognition success count for the second image to the character-recognition success count for the first image or a difference between the character-recognition success count for the second image and the character-recognition success count for the first image satisfies a predetermined determination condition; and a limited resizing ratio determiner that determines, as a limited resizing ratio for the first image, the resizing ratio for the second image determined to satisfy the determination condition.

### INCORPORATION BY REFERENCE

This application claims priority under Section 119 of U.S.C. to Japanese Patent Application No. 2023-097586 filed on Jun. 14, 2023, the entire content of which is incorporated herein by reference.

### BACKGROUND

The disclosure relates to an image processing apparatus, an image processing method, and an image processing program with which image processing is executed on image data including characters and the like.

An image processing apparatus disclosed in JP 2006-166217 A optically reads a document image, recognizes characters included in the document, and recognizes the size of the smallest character. How much the size of the recognized smallest character is reduced and printed is calculated, and when the size is reduced to be smaller than a preset size, the copying operation stops.

### SUMMARY

An image processing apparatus of the disclosure includes: a second image generator that generates, based on a first image, at least one second image obtained by reducing the first image at a predetermined resizing ratio; a character-recognition success count determiner that performs character recognition on the first image and the second image and determines a character-recognition success count for the first image that is the number of characters for which the character recognition on the first image is successful and a character-recognition success count for the second image that is the number of characters for which the character recognition on the second image is successful; a condition determiner that determines, for the second image, whether a ratio of the character-recognition success count for the second image to the character-recognition success count for the first image or a difference between the character-recognition success count for the second image and the character-recognition success count for the first image satisfies a predetermined determination condition; and a limited resizing ratio determiner that determines, as a limited resizing ratio for the first image, the resizing ratio for the second image determined to satisfy the determination condition by the condition determiner.

An image processing method of the disclosure includes: a second image generating step of generating, based on a first image, at least one second image obtained by reducing the first image at a predetermined resizing ratio; a character-recognition success count determining step of performing character recognition on the first image and the second image and determining a character-recognition success count for the first image that is the number of characters for which the character recognition on the first image is successful and a character-recognition success count for the second image that is the number of characters for which the character recognition on the second image is successful; a condition determining step of determining, for the second image, whether a ratio of the character-recognition success count for the second image to the character-recognition success count for the first image or a difference between the character-recognition success count for the second image and the character-recognition success count for the first image satisfies a predetermined determination condition; and a limited resizing ratio determining step of determining, as a limited resizing ratio for the first image, the resizing ratio for the second image determined to satisfy the determination condition in the condition determining step.

A non-transitory tangible computer-readable recording medium of the disclosure is a non-transitory tangible computer-readable recording medium storing an image processing program for causing a computer to execute image processing. The image processing includes: a second image generating step of generating, based on a first image, at least one second image obtained by reducing the first image at a predetermined resizing ratio; a character-recognition success count determining step of performing character recognition on the first image and the second image and determining a character-recognition success count for the first image that is the number of characters for which the character recognition on the first image is successful and a character-recognition success count for the second image that is the number of characters for which the character recognition on the second image is successful; a condition determining step of determining, for the second image, whether a ratio of the character-recognition success count for the second image to the character-recognition success count for the first image or a difference between the character-recognition success count for the second image and the character-recognition success count for the first image satisfies a predetermined determination condition; and a limited resizing ratio determining step of determining, as a limited resizing ratio for the first image, the resizing ratio for the second image determined to satisfy the determination condition in the condition determining step.

### BRIEF DESCRIPTION OF THE DRAWINGS

FIG. 1 is a diagram illustrating an example of a schematic configuration of an image processing apparatus 100 according to an embodiment of the disclosure.

FIG. 2 is a block diagram illustrating a configuration of the image processing apparatus 100.

FIG. 3 is a diagram illustrating an example of how the number of characters successfully recognized by OCR changes when the image processing apparatus 100 reduces image data 20 in a stepwise manner.

FIG. 4 is a flowchart illustrating processing of reducing the image data 20 by the image processing apparatus 100.

FIG. 5 is a flowchart illustrating a first modification of the processing of reducing the image data 20 by the image processing apparatus 100.

FIG. 6 is a flowchart illustrating a second modification of the processing of reducing the image data 20 by the image processing apparatus 100.

### DETAILED DESCRIPTION

An embodiment of the disclosure will be described below with reference to the drawings. In the drawings, the same or equivalent components are denoted by the same reference numerals and signs, and description thereof will not be repeated.

### 1. Configuration of Image Processing Apparatus 100

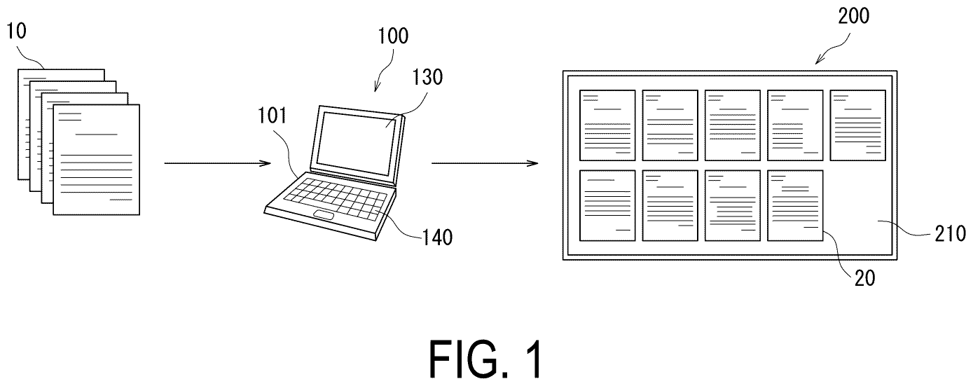

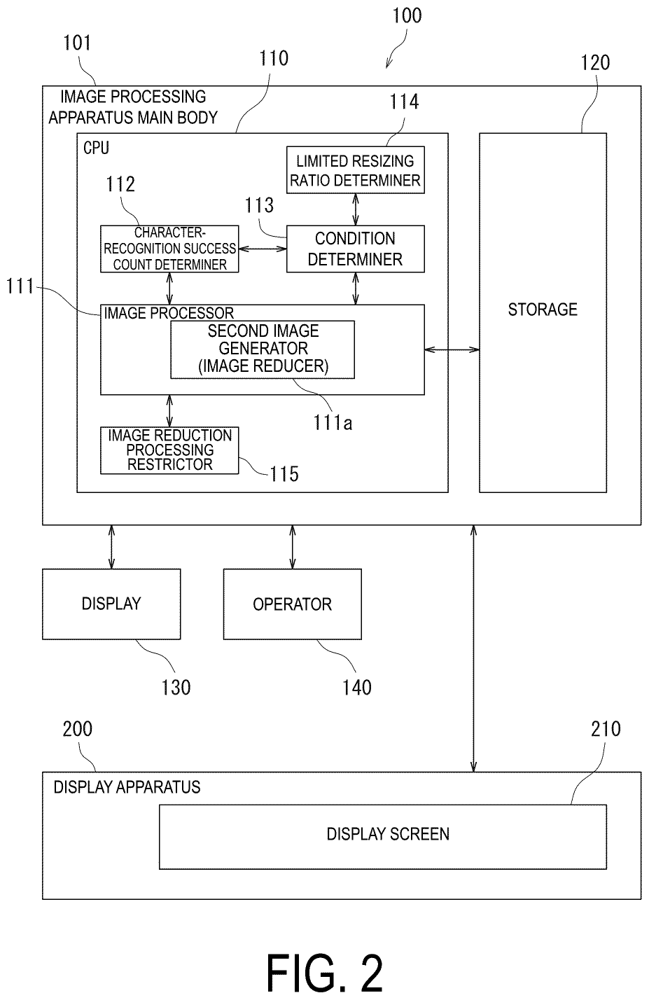

FIG. 1 is a diagram illustrating an example of a schematic configuration of an image processing apparatus 100 according to an embodiment of the disclosure. FIG. 2 is a block diagram illustrating a configuration of the image processing apparatus 100.

As illustrated in these FIGS. 1 and 2, the image processing apparatus 100 includes an image processing apparatus main body 101, a display 130, and an operator 140. The image processing apparatus 100 is mutually communicably connected to a display apparatus 200 including a display screen 210. Thus, the image processing apparatus 100 can display, for example, the generated output layout on the display apparatus 200.

Here, the image processing apparatus 100 is embodied by a laptop computer. The image processing apparatus 100 may also be embodied by a desktop personal computer, a tablet, a smartphone, and the like, but is not limited to these. Examples of the display apparatus 200 include, but are not limited to, a digital bulletin board, an electronic blackboard, a large monitor, and the like. Since the configuration of the display apparatus 200 is similar to that of a general display, a detailed description thereof will be omitted.

Here, the display 130 displays, for example, the output layout being generated. Examples of the display 130 include liquid crystal and organic electro-luminescence (EL) but are not limited thereto. Examples of the operator 140 include, but are not limited to, a mouse and a keyboard for selecting an image to be reduced or moved during the generation of the output layout. The display 130 and the operator 140 may be integrated with each other using a touch panel or the like that enables a touch operation or the like.

As illustrated in FIG. 2, the image processing apparatus main body 101 includes a central processing unit (CPU) 110 that controls each component, and a storage 120. Since the hardware configuration of the image processing apparatus main body 101 is similar to that of a general computer, a detailed description thereof will be omitted.

The CPU 110 includes an image processor 111 including a second image generator 111a, a character-recognition success count determiner 112, a condition determiner 113, a limited resizing ratio determiner 114, and an image reduction processing restrictor 115. Each of these components is realized when, for example, the CPU 110 executes software of a function corresponding to the component.

The image processor 111 reads the image data 20 stored in the storage 120, and executes various types of image processing including equal aspect resizing processing of enlarging or reducing the image data 20 while maintaining the aspect ratio of the original image, and the like. Here, an input image and an output image of the image processing will be referred to as a “first image” and a “second image”, respectively. The image data 20 just read from the storage 120 for image processing corresponds to the input image, and thus is an example of the “first image”.

The second image generator 111a generates, based on the first image, at least one second image obtained by reducing the first image at a predetermined resizing ratio. In other words, the second image generator 111a reduces the first image as the input image at the predetermined resizing ratio to generate at least one second image as the output image. An example of the predetermined resizing ratio includes a resizing ratio for reducing the original size by 10%. In this case, when the size of the first image is set as a standard (100%), the size of the second image is 90%. However, the resizing ratio is not limited to such a resizing ratio. When the second image generator 111a generates a plurality of the second images, the resizing ratios based on the first image are made different from each other.

The character-recognition success count determiner 112 performs character recognition on the first image and the second image and determines a character-recognition success count for the first image that is the number of characters for which the character recognition on the first image is successful and a character-recognition success count for the second image that is the number of characters for which the character recognition on the second image is successful. The character recognition is performed by, for example, optical character recognition (OCR). For example, the OCR may be incorporated in a scanner driver or may use an independent application, but the method is not limited thereto. However, the character recognition is not limited to OCR.

The condition determiner 113 determines, for the second image, whether a predetermined determination condition is satisfied by a ratio of the character-recognition success count for the second image to the character-recognition success count for the first image or a difference between the character-recognition success count for the second image and the character-recognition success count for the first image.

The limited resizing ratio determiner 114 determines, as a limited resizing ratio for the first image, the resizing ratio for the second image determined to satisfy the determination condition by the condition determiner 113.

With the image processing apparatus 100 having such a configuration, the resizing ratio of the second image determined to satisfy the determination condition by the condition determiner 113 is determined as the limited resizing ratio for the first image. Therefore, it is possible to determine the limit of the resizing ratio not resulting in much difficulty in reading of the image data 20 by a person. As a result, the image data 20 including a character can be reduced with a lowest possible risk of making the character impossible to read due to collapsing or the like. Further, regardless of whether the character is clear or is smudgy or blurred, the character-recognition success count for the second image changes when the character fails to be recognized as a character by, for example, OCR or the like. As a result, the image processing apparatus 100 can accurately determine the limited resizing ratio.

The condition determiner 113 may determine that the determination condition is satisfied when the ratio of the character-recognition success count for the second image to the character-recognition success count for the first image is equal to or higher than a predetermined ratio determination threshold, or a difference between the character-recognition success count for the second image and the character-recognition success count for the first image is equal to or smaller than a predetermined difference determination threshold. Therefore, by using the ratio or the difference based on the character-recognition success count for the first image, the determination of the resizing ratio limit is easily and objectively performed. As a result, the image processing apparatus 100 can more accurately determine the limited resizing ratio.

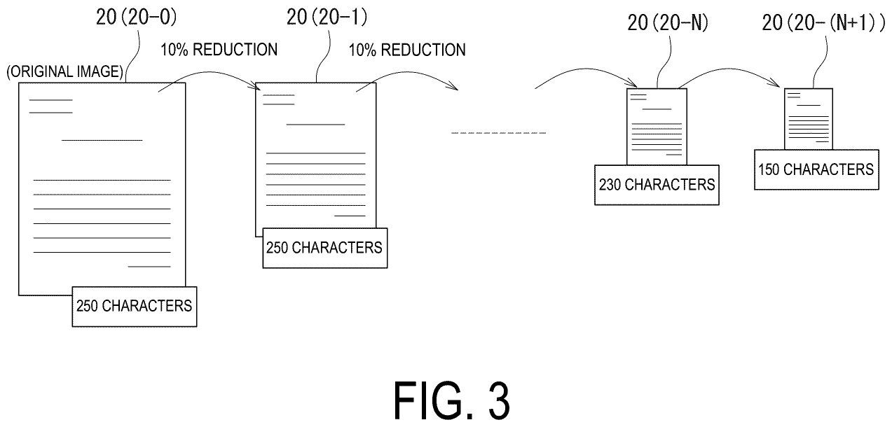

For example, assuming that an original image data 20-0 illustrated in FIG. 3 is the first image, the character-recognition success count for the first image is 250. Assuming that image data 20-N after the reduction is performed N times is the second image, since the character-recognition success count for the second image is 230, the ratio is 92% (obtained by dividing 230 by 250), and the difference is 20 (obtained by subtracting 230 from 250) characters. Assuming that image data 20-(N+1) after the reduction is performed (N+1) times is the second image, since the character-recognition success count for the second image is 150, the ratio is 60% (obtained by dividing 150 by 250), and the difference is 100 (obtained by subtracting 150 from 250) characters. The predetermined ratio determination threshold value may be, for example, 75%, but is not limited to such a ratio. For example, if the standard number of characters included in each page of a document 10 is known, the difference may be used as the determination condition.

Furthermore, each component of the CPU 110 may be configured as follows. Specifically, the second image generator 111a generates a plurality of second images each obtained by reducing the first image at a plurality of different resizing ratios. The character-recognition success count determiner 112 determines the character-recognition success count for the second image for each of the plurality of second images. The condition determiner 113 determines, for each of the plurality of second images, whether the ratio of the character-recognition success count for the second image to the character-recognition success count for the first image or the difference therebetween satisfies the determination condition. The limited resizing ratio determiner 114 determines, as the limited resizing ratio of the first image, the resizing ratio of the second image generated with the lowest resizing ratio among the second images determined to satisfy the determination condition by the condition determiner 113.

According to the image processing apparatus 100 having such a configuration, a plurality of second images each obtained by reducing the first image at a plurality of different resizing ratios are collectively generated. As a result, the limited resizing ratio of the first image can be quickly calculated.

Furthermore, each component of the CPU 110 may be configured as follows. Specifically, the second image generator 111a generates a plurality of second images by repeatedly executing the processing of generating the second image while decreasing the resizing ratio stepwise. The character-recognition success count determiner 112 determines the character-recognition success count for the second image for each of the plurality of second images. The condition determiner 113 determines, for each of the plurality of second images, whether the ratio of the character-recognition success count for the second image to the character-recognition success count for the first image or the difference therebetween satisfies the determination condition. The limited resizing ratio determiner 114 determines, as the limited resizing ratio for the first image, the resizing ratio for the second image immediately before the condition determiner 113 first determines that the determination condition is not satisfied.

According to the image processing apparatus 100 having such a configuration, the second images are generated one by one in a stepwise manner. As a result, the load of each second image generation processing is reduced.

The image processing apparatus 100 may further include the image reduction processing restrictor 115 that restricts processing of reducing the first image at a resizing ratio lower than the limited resizing ratio. Therefore, it is possible to restrict the processing of reducing the image at a resizing ratio that is highly likely to result in difficulty in reading by a person. As a result, inappropriate and unnecessary reduction processing is avoided.

The operator 140 that accepts an instruction for the reduction of the first image may be further provided, and the image reduction processing restrictor 115 may implement the restriction by making the operator 140 not receive operation of instructing reduction of the first image at a ratio lower than the limited resizing ratio. Therefore, it is possible to not to accept operation of instructing reduction of the image at a resizing ratio that is highly likely to result in difficulty in reading by a person. As a result, inappropriate and unnecessary reduction processing is avoided.

### 2. Example of Stepwise Reduction of Image Data 20 by Image Processing Apparatus 100

FIG. 3 is a diagram illustrating an example of how the number of characters successfully recognized by OCR changes when the image processing apparatus 100 reduces image data 20 in a stepwise manner.

When generating the output layout, the user uses the image processing apparatus 100 to adjust the size of the image data 20 obtained by scanning the document 10. The image processing apparatus 100 determines the limit of the resizing ratio not resulting in a difficulty in a person reading the image data, and reduces the image data 20 at the resizing ratio. The user appropriately arranges the image data 20 whose size has been thus adjusted. By repeating such a procedure, the user can complete the output layout.

As illustrated in FIG. 3, for example, it is assumed that the character-recognition success count in the original image data 20-0 is 250 characters. When the reference numerals of the image data 20 of the document 10 need to be distinguished from one another, the number of times of reduction is also written. For example, image data after the reduction performed once is referred to as image data 20-1, and image data after reduction performed twice is referred to as image data 20-2. Thus, image data before the reduction is the image data 20-0, and image data obtained after the reduction is performed N times is the image data 20-N.

Also in the image data 20-1 obtained by reducing the original image data 20-0 by 10%, the character-recognition success count was 250 characters. Thereafter, the reduction is repeated in a stepwise manner, that is, 10% at a time, and in the image data 20-N after the reduction is performed N times, the character-recognition success count was reduced to 230 characters. In other words, the character-recognition success count was reduced from 250 characters first obtained to 230 characters. The difference is 20 (obtained by subtracting 230 from 250) characters, and the ratio is 92% (obtained by dividing 230 by 250). This level of reduction in the character-recognition success count is considered to not to prevent a person from reading the image data 20 displayed on the display apparatus 200.

However, in the image data 20-(N+1) as a result of performing the reduction one more time, that is, a result of the reduction performed (N+1) times, a sharp decrease in the character-recognition success count to 150 characters was confirmed. In other words, the character-recognition success count sharply decreased from 250 characters first obtained to 150 characters. The difference in this case is 100 (obtained by subtracting 150 from 250) characters, and the ratio is 60% (obtained by dividing 150 by 250). Such a sharp decrease in the character-recognition success count is highly likely to result in difficulty in reading of the image data 20 displayed on the display apparatus 200.

Then, whether the ratio after the decrease in the character-recognition success count satisfies a predetermined determination condition is determined. Specifically, whether the ratio is equal to or higher than a predetermined ratio (for example, 75%) is determined. In other words, a ratio equal to or higher than the predetermined ratio is determined not to result in much difficulty in reading of the image data 20 by a person. In the example illustrated in FIG. 3, the image data 20-N after the reduction is performed N times does not result in much difficulty in reading, but the image data 20-(N+1) after the reading is performed (N+1) times is likely to result in difficulty in reading. Therefore, the size as a result of the immediately preceding reduction (after the reduction is performed N times) corresponds to the practical lower limit size after the reduction. Since the reduction of the original image data 20-0 is performed in a stepwise manner, that is 10% at a time, the resizing ratio of the image data 20-N after the reduction is performed N times, that is, N×10% corresponds to the limited resizing ratio.

### 3. Processing of Reducing Image Data 20 by Image Processing Apparatus 100

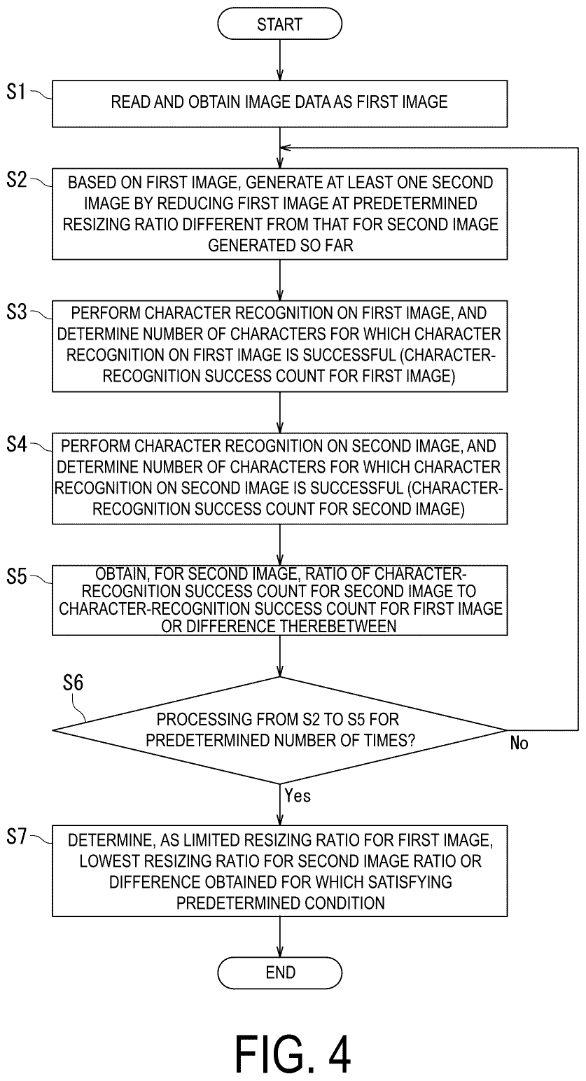

FIG. 4 is a flowchart illustrating processing of reducing the image data 20 by the image processing apparatus 100.

As illustrated in FIG. 4, first of all, in step S1, the image processor 111 reads the image data 20 stored in the storage 120 and sets it as the first image. Then, the processing proceeds to the next step S2.

In step S2, the second image generator 111a generates, based on the first image, at least one second image obtained by reducing the first image at a predetermined resizing ratio different from those for the second images generated so far. The second image generator 111a generates, based on the first image in the case of the first time, at least one second image reduced at a predetermined resizing ratio set in advance as an initial resizing ratio. Thereafter, the processing proceeds to the next step S3. In generating a plurality of second images, the second image generator 111a makes resizing ratios based on the first image different from each other. This step S2 is an example of a “second image generating step” of the disclosure.

In step S3, the character-recognition success count determiner 112 performs character recognition on the first image and determines the number of characters for which the character recognition on the first image is successful (the character-recognition success count for the first image), and the processing proceeds to the next step S4. After step S3 is executed once, step S3 does not need to be executed again unless the first image is changed.

In step S4, the character-recognition success count determiner 112 performs character recognition on the second image and determines the number of characters for which the character recognition on the second image is successful (the character-recognition success count for the second image), and the processing proceeds to the next step S5. Step S3 and step S4 are examples of the “character-recognition success count determining step” of the disclosure, and may be executed simultaneously.

In step S5, the condition determiner 113 obtains, for the second image, a ratio of the character-recognition success count for the second image to the character-recognition success count for the first image or the difference therebetween, and the processing proceeds to the next step S6.

In step S6, the condition determiner 113 determines whether the processing from S2 to S5 has been repeated a predetermined number of times. When the processing from S2 to S5 has not been repeated a predetermined number of times, the condition determiner 113 repeats the processing in step S2 and after. When the processing from S2 to S5 has been repeated a predetermined number of times, the processing proceeds to the next step S7. This step S6 is an example of a “condition determining step” of the disclosure.

In step S7, the limited resizing ratio determiner 114 determines whether each of the second images generated so far satisfies a predetermined condition, determines, as the limited resizing ratio for the first image, the minimum resizing ratio from among the resizing ratios for all the second images satisfying the predetermined condition, and then ends the series of processes. This step S7 is an example of a “limited resizing ratio determining step” of the disclosure.

### 4. First Modification of Processing of Reducing Image Data 20 by Image Processing Apparatus 100

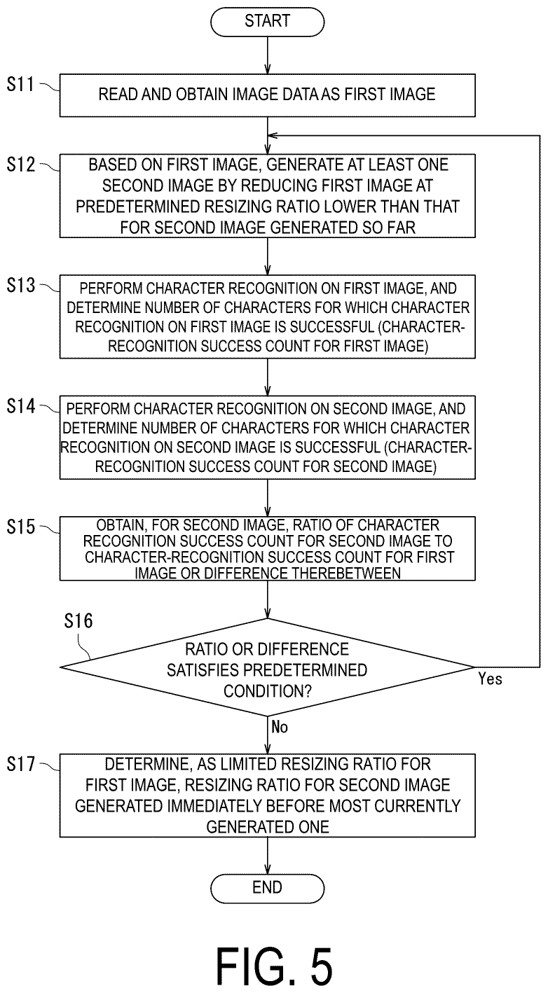

FIG. 5 is a flowchart illustrating a first modification of the processing of reducing the image data 20 by the image processing apparatus 100. According to this first modification, a plurality of second images are generated by repeatedly executing the processing of generating the second image while decreasing the resizing ratio stepwise.

As illustrated in FIG. 5, first of all, in step S11, the image processor 111 reads the image data 20 stored in the storage 120 and sets it as the first image as in step S1. Then, the processing proceeds to the next step S12.

In step S12, the second image generator 111a generates, based on the first image, at least one second image obtained by reducing the first image at a predetermined resizing ratio lower than those for the second images generated so far. For example, the second image generator 111a generates at least one second image reduced at a resizing ratio lower by 10% than the resizing ratio of the second image immediately previously generated. At least one second image reduced at a predetermined resizing ratio set in advance as an initial resizing ratio is generated based on the first image in the case of the first time. Thereafter, the processing proceeds to the next step S13.

Steps S13 to S15 are the same as steps S3 to S5 described above, and thus description thereof is omitted.

In step S16, the condition determiner 113 determines whether the immediately preceding second image generated satisfies a predetermined condition. When the immediately preceding second image generated satisfies the predetermined condition, the processing in step S12 and after is repeated. When the immediately preceding second image generated does not satisfy the predetermined condition, the processing proceeds to the next step S17 without repeating the processing in step S12 and after.

In step S17, the limited resizing ratio determiner 114 determines the resizing ratio for the immediately preceding second image generated before the most currently generated second image (the image determined not to satisfy the predetermined condition for the first time) as the limited resizing ratio for the first image, and then ends the series of processes.

### 5. Second Modification of Processing of Reducing Image Data 20 by Image Processing Apparatus 100

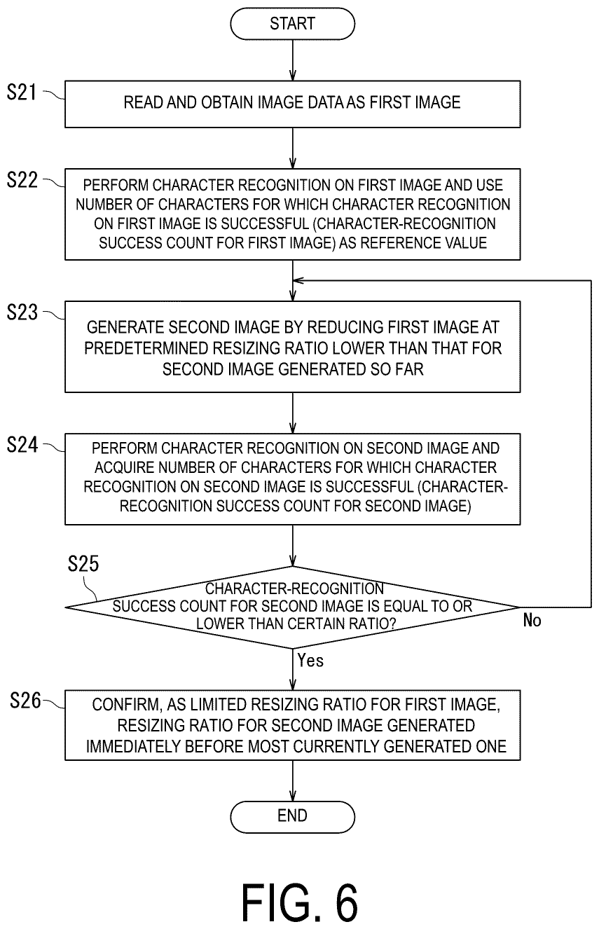

FIG. 6 is a flowchart illustrating a second modification of the processing of reducing the image data 20 by the image processing apparatus 100.

As illustrated in FIG. 6, first of all, in step S21, the image processor 111 reads the image data 20 stored in the storage 120 and sets it as the first image as in step S1. Then, the processing proceeds to the next step S22.

In step S22, the character-recognition success count determiner 112 performs character recognition on the first image and uses the number of characters for which the character recognition on the first image is successful (the character-recognition success count for the first image) as a reference value, and the processing proceeds to the next step S23.

In step S23, the second image generator 111a generates, based on the first image, at least one second image obtained by reducing the first image at a predetermined resizing ratio lower than those for the second images generated so far. For example, the second image generator 111a generates at least one second image reduced at a resizing ratio lower by 10% than the resizing ratio of the second image immediately previously generated. At least one second image reduced at a predetermined resizing ratio set in advance as an initial resizing ratio is generated based on the first image in the case of the first time. Thereafter, the processing proceeds to the next step S24.

In step S24, the character-recognition success count determiner 112 performs character recognition on the second image and acquires the number of characters for which the character recognition on the second image is successful (the character-recognition success count for the second image) as a reference value, and the processing proceeds to the next step S25.

In step S25, the condition determiner 113 determines whether the ratio of the character-recognition success count for the second image to the character-recognition success count for the first image is equal to or lower than a predetermined ratio. The processing proceeds to the next step S26 when this condition is satisfied, and returns to step S23 when the condition is not satisfied.

In step S26, the limited resizing ratio determiner 114 determines the resizing ratio of the immediately preceding second image generated before the most currently generated second image (the image determined not to satisfy the predetermined condition for the first time) as the limited resizing ratio for the first image, and then ends the series of processes.

In step S24, if the character-recognition success count for the second image has sharply decreased from the previous count, there is a possibility that the one resizing ratio is too high. In such a case, for example, the resizing ratio in step S23 may be reduced and the processing may be repeated. In this way, a more accurate limited resizing ratio can be obtained for the first image.

The disclosure may be embodied in other various forms without departing from the spirit or essential characteristics thereof. Thus, the above embodiments are merely examples in all respects and should not be interpreted as limiting. The scope of the disclosure is indicated by the claims and is not limited to the description. Furthermore, all modifications and changes equivalent in scope with the claims are included in the scope of the disclosure.

1. An image processing apparatus comprising:
a second image generator that generates, based on a first image, at least one second image obtained by reducing the first image at a predetermined resizing ratio;
a character-recognition success count determiner that performs character recognition on the first image and the second image and determines a character-recognition success count for the first image that is the number of characters for which the character recognition on the first image is successful and a character-recognition success count for the second image that is the number of characters for which the character recognition on the second image is successful;
a condition determiner that determines, for the second image, whether a ratio of the character-recognition success count for the second image to the character-recognition success count for the first image or a difference between the character-recognition success count for the second image and the character-recognition success count for the first image satisfies a predetermined determination condition; and
a limited resizing ratio determiner that determines, as a limited resizing ratio for the first image, the resizing ratio for the second image determined to satisfy the determination condition by the condition determiner.

2. The image processing apparatus according to claim 1, wherein the condition determiner determines that the determination condition is satisfied when the ratio of the character-recognition success count for the second image to the character-recognition success count for the first image is equal to or higher than a predetermined ratio determination threshold or the difference between the character-recognition success count for the second image and the character-recognition success count for the first image is equal to or smaller than a predetermined difference determination threshold.

3. The image processing apparatus according to claim 1, wherein
the second image generator generates a plurality of the second images each obtained by reducing the first image at a plurality of different resizing ratios,
the character-recognition success count determiner determines the character-recognition success count for the second image for each of the plurality of the second images,
the condition determiner determines, for each of the plurality of the second images, whether the ratio of the character-recognition success count for the second image to the character-recognition success count for the first image or the difference between the character-recognition success count for the second image and the character-recognition success count for the first image satisfies the determination condition, and
the limited resizing ratio determiner determines, as the limited resizing ratio for the first image, a lowest one of the resizing ratios for the second images determined to satisfy the determination condition by the condition determiner.

4. The image processing apparatus according to claim 1, wherein
the second image generator generates a plurality of the second images by repeatedly executing processing of generating the second image while decreasing the resizing ratio stepwise,
the character-recognition success count determiner determines the character-recognition success count for the second image for each of the plurality of the second images,
the condition determiner determines, for each of the plurality of the second images, whether the ratio of the character-recognition success count for the second image to the character-recognition success count for the first image or the difference between the character-recognition success count for the second image and the character-recognition success count for the first image satisfies the determination condition, and
the limited resizing ratio determiner determines, as the limited resizing ratio for the first image, the resizing ratio for the second image generated immediately before the second image first determined not to satisfy the determination condition by the condition determiner.

5. The image processing apparatus according to claim 1, further comprising an image reduction processing restrictor that restricts processing of reducing the first image at a resizing ratio lower than the limited resizing ratio.

6. The image processing apparatus according to claim 5, further comprising an operator that receives operation of instructing reduction of the first image, wherein
the image reduction processing restrictor restricts the operator from accepting operation of instructing reduction of the first image at a resizing ratio lower than the limited resizing ratio.

7. An image processing method comprising:
a second image generating step of generating, based on a first image, at least one second image obtained by reducing the first image at a predetermined resizing ratio;
a character-recognition success count determining step of performing character recognition on the first image and the second image and determining a character-recognition success count for the first image that is the number of characters for which the character recognition on the first image is successful and a character-recognition success count for the second image that is the number of characters for which the character recognition on the second image is successful;
a condition determining step of determining, for the second image, whether a ratio of the character-recognition success count for the second image to the character-recognition success count for the first image or a difference between the character-recognition success count for the second image and the character-recognition success count for the first image satisfies a predetermined determination condition; and
a limited resizing ratio determining step of determining, as a limited resizing ratio for the first image, the resizing ratio for the second image determined to satisfy the determination condition in the condition determining step.

8. A non-transitory tangible computer-readable recording medium storing an image processing program for causing a computer to execute image processing,
the image processing comprising:
a second image generating step of generating, based on a first image, at least one second image obtained by reducing the first image at a predetermined resizing ratio;
a character-recognition success count determining step of performing character recognition on the first image and the second image and determining a character-recognition success count for the first image that is the number of characters for which the character recognition on the first image is successful and a character-recognition success count for the second image that is the number of characters for which the character recognition on the second image is successful;
a condition determining step of determining, for the second image, whether a ratio of the character-recognition success count for the second image to the character-recognition success count for the first image or a difference between the character-recognition success count for the second image and the character-recognition success count for the first image satisfies a predetermined determination condition; and
a limited resizing ratio determining step of determining, as a limited resizing ratio for the first image, the resizing ratio for the second image determined to satisfy the determination condition in the condition determining step.
